(19) United States
(12) Patent Application Publication
(10) Pub. No.: US 2023/0388326 A1
(43) Pub. Date: Nov. 30, 2023

(54) METHOD AND APPARATUS FOR DETECTING MALICIOUS MAIL BASED ON USER INFORMATION

(71) Applicant: SAMSUNG SDS CO., LTD., Seoul (KR)

(72) Inventor: Jong Won PARK, Seoul (KR)

(73) Assignee: SAMSUNG SDS CO., LTD., Seoul (KR)

(21) Appl. No.: 18/203,944

(22) Filed: May 31, 2023

(30) Foreign Application Priority Data
May 31, 2022 (KR) 10-2022-0066499

(51) Int. Cl. H04L 9/40

(52) U.S. Cl. CPC H04L 63/1425; H04L 63/1416; H04L 63/20

(57) ABSTRACT

Provided are a method and an apparatus for detecting malicious mail based on user information. The method according to some embodiments may include obtaining account characteristic information of an account of a user; detecting a reception of a detection target mail in the account of the user; and detecting whether the detection target mail received in the account of the user is a malicious mail by using the account characteristic information.

### CROSS-REFERENCE TO RELATED APPLICATION

This application claims priority from Korean Patent Application No. 10-2022-0066499 filed on May 31, 2022 in the Korean Intellectual Property Office, and all the benefits accruing therefrom under 35 U.S.C. 119, the contents of which in its entirety are herein incorporated by reference.

### BACKGROUND

### 1. Technical Field

The present disclosure relates to a method and apparatus for detecting a malicious mail based on user information, and more particularly, to a method and an apparatus for detecting a malicious mail capable of efficiently detecting an attack of malicious mail transmitted into a system based on user information obtained from the system.

### 2. Description of the Related Art

A scam mail (or scam e-mail) attack refers to an act of stealing money by hacking a company's e-mail information or disguising itself as a business partner. These scam mails may cause great financial damage to companies or individuals.

FIG. 1 is a diagram for explaining damage caused by a conventional scam mail received from the outside. The damage through the conventional scam mail may occur, for example, in the following flow. However, since the damage through scam mail may start to occur when the risk target (scam mail sender) succeeds in hacking at least one of A or B, it may occur in a flow different from the following.

(1) B, requesting the transaction price, sends a mail requesting payment of the transaction price to A, (2) the risk target (scam mail sender) monitors that A replies to the B's mail, and (3) (4) the risk target then registers domains similar to mails of A and B. (5) The risk target sends a mail requesting payment of transaction price to B after partially modifying the mail requesting payment of transaction price from A to the registered address, and (6) receives the transaction price from B. (7) At this time, the risk target sends a mail disguised as deposit delay to B, and attempts an additional scam attack on B.

Conventionally, there has been a method for detecting the attack of the scam mail as described above. However, the conventional method for detecting the attack of the scam mail uses only information on a sender of the scam mail, and even when this information is used, most of the methods were able to detect the scam mail with the help of an external server when the scam mail corresponds to a known address.

Therefore, conventionally, it was difficult to detect the scam mail in the case of an unknown address of the scam mail. In addition, since all mails had to be examined collectively to detect the scam mail, excessive detection operations were performed in the detection of scam mails. As a result, unnecessary resources were wasted and excessive costs were incurred.

In addition, conventionally, the performance of the scam attack detection technology is relatively poor compared to the malware and virus detection technology. Accordingly, a technology capable of more efficiently and accurately detecting a scam attack is required.

### SUMMARY

Aspects of the present disclosure are to efficiently detect malicious mails in association with a system in which various types of user information is managed.

Aspects of the present disclosure are also to accurately detect malicious mails by considering a logical flow based on a user's mail history and characteristics of the user.

Aspects of the present disclosure are also to reduce resource consumption and cost due to excessive detection in detecting malicious mails.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of an example embodiment of the present disclosure, provided is a method for detecting a malicious mail performed by at least one processor, the method including: obtaining account characteristic information of an account of a user; detecting a reception of a detection target mail in the account of the user; and detecting whether the detection target mail received in the account of the user is a malicious mail by using the account characteristic information.

The account characteristic information may include at least one of a risk keyword usage frequency indicating a frequency at which a pre-designated risk keyword is used in the account of the user, a risk keyword transmission frequency indicating a frequency at which a mail including the pre-designated risk keyword is transmitted from the account of the user, address book information set in the account of the user, or transmission and/or reception history information of a mail in the account of the user.

The obtaining the account characteristic information may include obtaining the account characteristic information of the account of the user by monitoring a mail transmitted to and/or received from the account of the user.

The method may further include, prior to the detecting whether the detection target mail is the malicious mail: determining logic for detecting whether the detection target mail is the malicious mail based on a security policy level set for the account of the user.

The detecting whether the detection target mail is the malicious mail may include determining the detection target mail as the malicious mail by using risk information of the detection target mail obtained from an external server.

The detecting whether the detection target mail is the malicious mail may include: identifying a keyword included in a body of the detection target mail; and determining whether a pre-designated risk keyword is included in the body of the detection target mail, and determining the detection target mail as a risk candidate mail based on the pre-designated risk keyword being included.

The account characteristic information may include a risk keyword usage frequency indicating a frequency at which a pre-designated risk keyword is used in the account of the user, and the detecting whether the detection target mail is the malicious mail may include determining the account of the user as a risk candidate account based on the risk keyword usage frequency in the account of the user exceeding a threshold usage frequency.

The account characteristic information may include a risk keyword transmission frequency indicating a frequency at which a mail including a pre-designated risk keyword is transmitted from the account of the user, and the detecting whether the detection target mail is the malicious mail may include determining the account of the user as a risk candidate account based on the risk keyword transmission frequency in the account of the user being within a threshold transmission frequency.

The account characteristic information may include an address book set in the account of the user, and the detecting whether the detection target mail is the malicious mail may include: identifying sender information in the detection target mail; and performing an operation of detecting whether the detection target mail is the malicious mail based on the sender information of the detection target mail not matching the address book.

The account characteristic information may include transmission and/or reception history information of the account of by the user, and the detecting whether the detection target mail is the malicious mail may include: identifying sender information in the detection target mail; and determining whether the sender information of the detection target mail matches the transmission and/or reception history information of the account of the user.

The detecting whether the detection target mail is the malicious mail may further include determining the detection target mail as the malicious mail based on the sender information of the detection target mail not matching the transmission and/or reception history information of the account of the user.

The detecting whether the detection target mail is the malicious mail may include: identifying sender information and recipient information included in a header of the detection target mail; calculating a similarity score based on a domain of the sender information and a domain of the recipient information included in the header of the detection target mail; and determining the detection target mail as the malicious mail, based on the calculated similarity score not being a perfect mismatch or a perfect match.

The detecting whether the detection target mail is the malicious mail may include: identifying sender information included in a header of the detection target mail and sender information included in a body of the detection target mail; calculating a similarity score based on a domain of the sender information included in the header of the detection target mail and a domain of the sender information included in the body of the detection target mail; and determining the detection target mail as the malicious mail, based on the calculated similarity score not being a perfect mismatch or a perfect match.

The method may further include: providing a risk notification capable of identifying the malicious mail to the detection target mail determined as the malicious mail.

According to an aspect of an example embodiment of the present disclosure, provided is a method for detecting a malicious mail performed by at least one processor, the method including: obtaining transmission and/or reception history information of an account of a user; detecting a reception of a detection target mail in the account of the user; and detecting whether the detection target mail is a malicious mail based on the transmission and/or reception history information of the account of the user and a pre-designated risk keyword.

The detecting whether the detection target mail is the malicious mail based on the transmission and/or reception history information of the mail of the user may include: calculating a score, which represents a contextual relationship between a thread of a mail already received in the account of the user and the detection target mail, the thread of the mail being included in the transmission and/or reception history information; and determining the detection target mail as the malicious mail based on the calculated score being a threshold value or less.

According to an aspect of an example embodiment of the present disclosure, provided is an apparatus for detecting a malicious mail, the apparatus including at least one processor to implement: a monitoring module configured to obtain account characteristic information of an account of a user by monitoring a mail transmission and/or reception operation in the account of the user; and an analysis module configured to detect, based on detection of a reception of a detection target mail in the account of the user, whether the detection target mail received in the account of the user is a malicious mail by using the account characteristic information.

The analysis module may include an individual analysis module configured to determine at least one of a risk candidate account or a risk candidate mail based on the account characteristic information.

The account characteristic information may include transmission and/or reception history information of the account of the user, and the analysis module may include a history analysis module configured to identify sender information included in the detection target mail and determine the malicious mail based on transmission and/or reception history information of the account of the user.

The analysis module may include a similarity analysis module configured to determine the detection target mail as the malicious mail by using sender information and recipient information included in a header of the detection target mail and sender information included in a body of the detection target mail.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a diagram for explaining damage caused by a conventional malicious mail received from the outside;

FIG. 2 is an exemplary diagram illustrating a schematic operation of detecting a malicious mail by an apparatus for detecting a malicious mail according to an exemplary embodiment of the present disclosure;

FIG. 3 is a block diagram illustrating a configuration of an apparatus for detecting a malicious mail according to an exemplary embodiment;

FIG. 4 is a block diagram for specifically explaining an individual analysis module described in FIG. 3;

FIG. 5 is a diagram for explaining risky keywords included in detection target mail;

FIG. 6 is an example of account characteristic information for each user account indicating the frequency of using risk keywords and the frequency of external mail transmission of risk keywords;

FIG. 7 is a diagram for explaining targets of a risk candidate account and a risk candidate mail determined by the individual analysis module;

FIG. 8 is a block diagram for specifically explaining a history analysis module described in FIG. 3;

FIG. 9 is a diagram for explaining transmission/reception history information of a user using e-mail and an address book set in a user account;

FIG. 10 is a block diagram for specifically explaining a similarity analysis module described in FIG. 3;

FIG. 11 is a diagram for explaining an operation of calculating a similarity score using sender information and recipient information included in a header of a detection target mail;

FIG. 12 is a diagram for explaining an operation of calculating a similarity score using sender information included in a header and sender information included in a body of a detection target mail;

FIG. 13 is a diagram for explaining a case in which logic for operating an analysis module is determined by an operation of a control module;

FIG. 14 is a diagram illustrating an example of displaying a risk notification on a detection target mail determined as a malicious mail;

FIG. 15 is a flowchart illustrating an operation of a method for detecting a malicious mail according to an exemplary embodiment;

FIG. 16 is a flowchart illustrating an operation in which logic for detecting a malicious mail is determined by a security policy level for a user account;

FIG. 17 is a flowchart schematically illustrating an operation of detecting a malicious mail;

FIG. 18 is a flowchart illustrating an operation of determining a detection target mail as a risk candidate mail by determining whether a detection target mail includes a pre-designated keyword;

FIG. 19 is a flowchart illustrating an operation of determining a user's account as a risk candidate account by determining whether a user's mail includes a pre-designated keyword;

FIG. 20 is a flowchart illustrating an operation of determining a malicious mail using a user's address book and transmission/reception history information;

FIG. 21 is a flowchart illustrating an operation of determining a malicious mail using sender information and recipient information included in the header and body of the detection target mail; and

FIG. 22 is a hardware configuration diagram of an apparatus for detecting a malicious mail according to another exemplary embodiment of the present disclosure.

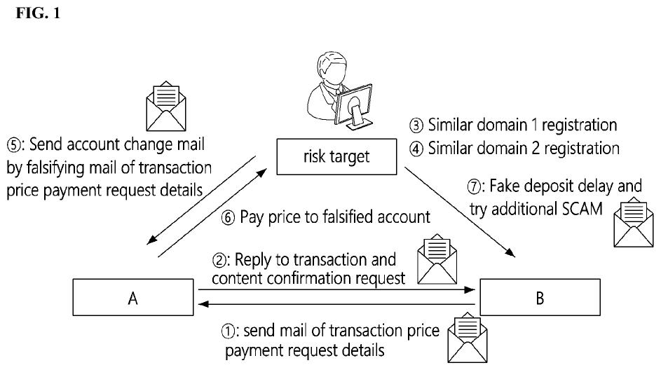

### DETAILED DESCRIPTION

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will be defined by the appended claims and their equivalents.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that may be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), may be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, some exemplary embodiments of the present disclosure will be described with reference to the accompanying drawings.

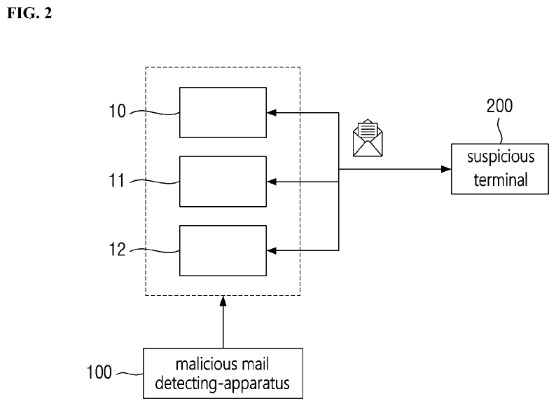

FIG. 2 is an exemplary diagram illustrating a schematic operation of detecting a malicious mail by an apparatus 100 for detecting a malicious mail according to an exemplary embodiment of the present disclosure.

Referring to FIG. 2, in the present specification, the apparatus 100 for detecting a malicious mail (or e-mail) may monitor detection target mails transmitted to and received from accounts 10, 11, and 12 of users and detect the malicious mail.

The apparatus 100 for detecting a malicious mail may be an apparatus for monitoring mails transmitted to and received from the accounts 10, 11, and 12 of the users. The apparatus 100 for detecting a malicious mail may monitor the mails transmitted to and received from the accounts 10, 11, and 12 of the users. In this case, the apparatus 100 for detecting a malicious may monitor detection target mails transmitted and received between the accounts 10, 11, and 12 of the users or may monitor detection target mails transmitted to and received from the outside. In an exemplary embodiment, the apparatus 100 for detecting a malicious may monitor all detection target mails transmitted to and received from the accounts 10, 11, and 12 of the users without distinguishing between mails transmitted and received with an internal terminal or mails transmitted and received with an external terminal.

In an exemplary embodiment, the account of the user may be an account managed by a system. In this case, the system may be an in-house groupware system, an in-house business system, a subsidiary message system, a supplier message system, an enterprise resource planning (ERP) system, or a web portal system, but is not limited thereto.

The detection target mail refers to the mail transmitted to and received from the account of the user. In an exemplary embodiment, the detection target mail may also refer to a mail transmitted/received from the account of the user to the outside.

The apparatus 100 for detecting a malicious mail may monitor detection target mail transmitted/received with a suspicious terminal 200 and detect the malicious mail. Here, the suspicious terminal 200 refers to a terminal that transmits a mail from the outside, and refers to a device that transmits and receives a mail with internal users of the system monitored by the apparatus for detecting a malicious mail. In addition, the suspicious terminal 200 is not limited to a name, and may refer to various devices such as a pre-identified terminal, an unidentified terminal, an unidentifiable terminal, or an external terminal.

The apparatus 100 for detecting a malicious mail may obtain account characteristic information of the accounts 10, 11, and 12 of the users. The account characteristic information may be information on a user's mail transmitting and receiving activities, but is not limited thereto, and may be various types of user information such as a user's mail log record, mail content, response time, personal schedule, and type of work.

The apparatus 100 for detecting a malicious mail may detect a reception of detection target mail for the account of the user, and may detect whether the detection target mail received in the account of the user is a malicious mail by using the account characteristic information.

The malicious mail refers to a scam mail, a spam mail, a fraud mail, a mail containing malicious code, etc., but is not limited thereto.

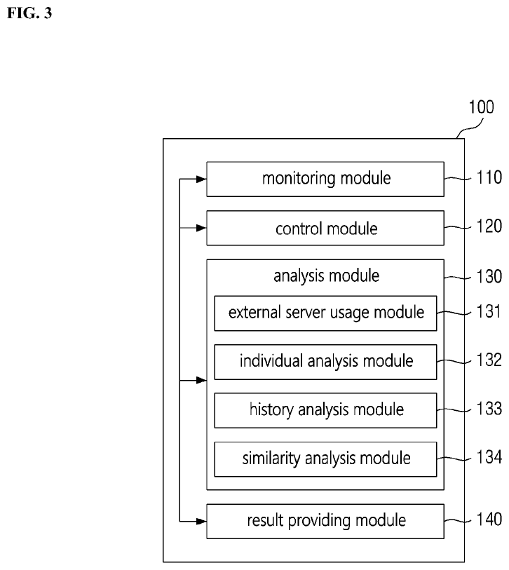

Hereinafter, a detailed operation of detecting whether the detection target mail is a malicious mail by the apparatus 100 for detecting a malicious mail will be described with reference to FIGS. 3 to 14.

FIG. 3 is a block diagram illustrating a configuration of an apparatus 100 for detecting a malicious mail according to an exemplary embodiment.

Referring to FIG. 3, the apparatus 100 for detecting a malicious mail may include a monitoring module 110, a control module 120, an analysis module 130, and a result providing module 140.

The monitoring module 110 may monitor a mail transmission/reception operation of an account of a user using a mail to obtain account characteristic information of the user. The monitoring module 110 may obtain the account characteristic information of the user using various types of information generated in a process of transmitting and receiving a mail. In an exemplary embodiment, the monitoring module 110 may obtain account characteristic information for each user account using various types of information usable in an in-house groupware system in which the account of the user is managed.

The account characteristic information may include at least one of a risk (or malicious) keyword usage frequency indicating a frequency at which a pre-designated risk keyword is used in the account of the user, a risk keyword transmission frequency indicating a frequency at which a mail including the pre-designated risk keyword is transmitted from the account of the user, address book information set in the account of the user, and transmission/reception history information on the mail used by the user. Details of the account characteristic information will be described later.

The control module 120 may determine logic for detecting whether the detection target mail is a malicious mail based on a security policy level set for the account of the user. The control module 120 may determine logic of the analysis module 130 according to a user policy level prior to an operation of the analysis module 130 to be described later.

In an exemplary embodiment, the security policy level may be set in advance, and may also be set differently for each user. The security policy level may be classified as a high level, a medium level, or a low level, and as the policy level is closer to the high level, it is possible to determine whether or not to perform the operation of the analysis module 130 to be described later or the order of performing the operation thereof. The above-described security policy level is an implementation example and may be implemented in various ways.

For example, the control module 120 may set various logics according to an internal security policy, a user's work sensitivity, a company's acceptable range of risks, and the like.

When the analysis module 130 detects a reception of detection target mail for the account of the user, the analysis module 130 may detect whether the detection target mail received in the account of the user is a malicious mail by using the account characteristic information.

The analysis module 130 may include an external server usage module 131, an individual analysis module 132, a history analysis module 133, and a similarity analysis module 134.

The external server usage module 131 may determine the detection target mail as a malicious mail by using risk (or malicious) information of the detection target mail obtained from an external server. Here, the external server is a server that manages information on senders who send malicious mails, such as scam mails and malicious code mails.

The individual analysis module 132 may determine a risk (or malicious) candidate account or a risk (or malicious) candidate mail based on the account characteristic information. As described above, the account characteristic information may include the risk keyword usage frequency indicating the frequency at which the pre-designated risk keyword is used in the account of the user or the risk keyword transmission frequency indicating the frequency at which the mail including the pre-designated risk keyword is transmitted from the account of the user.

The individual analysis module 132 may determine the risk candidate account and the risk candidate mail by using the risk keyword usage frequency or the risk keyword transmission frequency. The risk candidate account and the risk candidate mail are information used by the analysis module 130 to determine the malicious mail. Specifically, the risk candidate account refers to an account of a user who has a possibility of receiving a malicious mail, and the risk candidate mail refers to detection target mail that has not yet been determined as the malicious mail, but may still be a malicious mail.

The history analysis module 133 may identify sender information included in the detection target mail, and may determine the malicious mail based on transmission/reception history information on the mail used by the user. As described above, the account characteristic information may include the address book information set in the account of the user or the transmission/reception history information on the mail used by the user.

In this case, when the sender information of the detection target mail does not match the user's address book included in the account characteristics information, the history analysis module 133 may perform an operation of detecting whether or not the detection target mail is a malicious mail. When the sender information of the detection target mail matches the user's address book included in the account characteristics information, the history analysis module 133 may determine that the detection target mail is not a malicious and may not perform the analysis module 130 anymore.

According to an exemplary embodiment, when a scam mail is detected using the user's transmission/reception history, a detection accuracy of the scam mail may be improved. The reason for this is that since the scam mail is transmitted and received continuously, it is necessary to analyze the history of the scam mail in order to improve detection performance of the scam mail.

The similarity analysis module 134 may determine the detection target mail as a malicious mail by using sender information and recipient information included in the header of the detection target mail and sender information included in the body of the detection target mail.

The result providing module 140 may provide a risk notification capable of identifying the malicious mail to the detection target mail determined as the malicious mail.

The components included in the apparatus 100 for detecting a malicious mail have been schematically described so far with reference to FIG. 3.

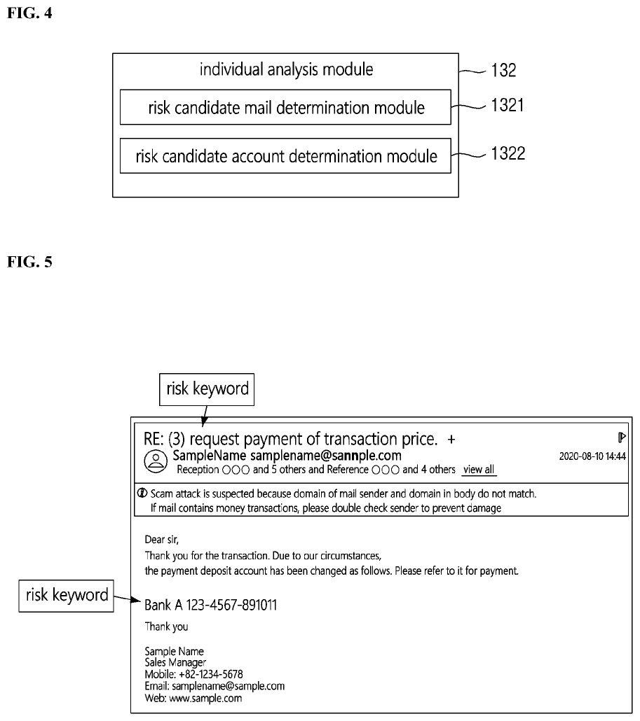

Hereinafter, the external server usage module 131, the individual analysis module 132, the history analysis module 133, and the similarity analysis module 134 included in the analysis module 130 will be described in detail with reference to FIGS. 4 to 13.

FIG. 4 is a block diagram for specifically explaining the individual analysis module 132 described in FIG. 3, and FIG. 5 is a diagram for explaining risk keywords included in detection target mail.

Referring to FIG. 4, the individual analysis module 132 may include a risk candidate mail determination module 1321 and a risk candidate account determination module 1322.

The candidate mail determining module may determine whether a pre-designated risk keyword is included in the keywords included in the body of the detection target mail, and may determine the detection target mail as a risk candidate mail when the pre-designated risk keyword is included.

Here, the pre-designated risk keyword may be a keyword related to a contract, purchase, or finance, but is not limited thereto.

When the detection target mail is received as illustrated in FIG. 5, keywords included in the body of the detection target mail may be identified. Here, the body of the detection target mail refers to all information other than a sender address and an originator address included in the detection target mail.

The subject of the detection target mail includes keywords such as ‘transaction price’ and ‘payment request’, and the body thereof includes ‘deposit account’, ‘bank name’, and ‘account number’. When the pre-designated risk keyword is a keyword related to a contract, purchase, or finance, the candidate mail determination module may determine the detection target mail as a risk candidate mail because the detection target mail includes ‘transaction price’, ‘payment request’, ‘deposit account’, ‘bank name’, and ‘account number’.

The risk candidate account determination module 1322 may determine a risk candidate account using the risk keyword.

When the risk keyword usage frequency in the account of the user exceeds a threshold usage frequency, the risk candidate account determination module 1322 may determine the account of the user as a risk candidate account.

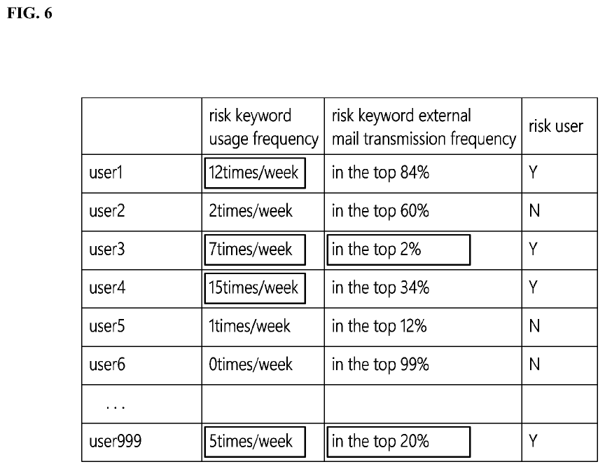

When the threshold usage frequency is 4 times per week, user 1, user 3, user 4, and user 999 in FIG. 6 exceed the threshold usage frequency, and therefore, user 1, user 3, user 4, and user 999 may be determined as risk candidate accounts. Here, user 2, user 5, and user 6 do not determine the detection target mail as a risk candidate account because the risk keyword usage frequency does not exceed the threshold usage frequency.

When the risk keyword transmission frequency in the account of the user exceeds a threshold transmission frequency, the risk candidate account determination module 1322 may determine the account of the user as a risk candidate account.

For example, assume that the threshold transmission frequency is in the top 25% of users. In this case, since user 3 and user 999 of FIG. 6 have the threshold transmission frequencies within the top 25%, user 3 and user 999 may be determined as risk candidate accounts. However, the numerical value of the threshold transmission frequency is not limited by such an example, and the threshold transmission frequency may be set to various values based on various factors (e.g., security policy, etc.).

The risk candidate account module may determine the risk candidate account based on any one of the risk keyword usage frequency or transmission frequency of mail including a pre-designated risk keyword transmitted from the account of the user.

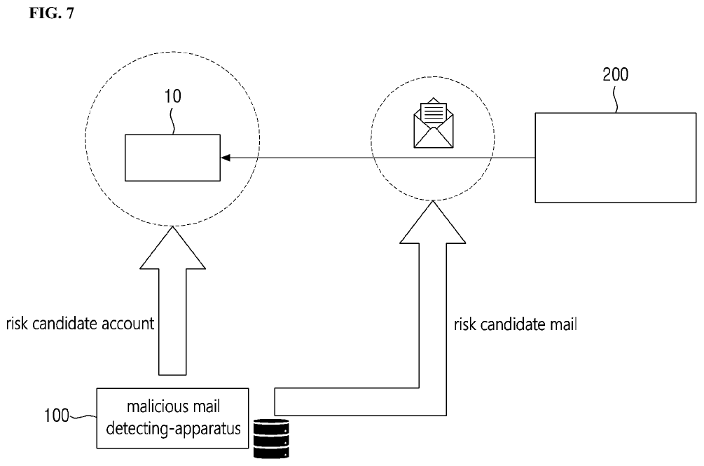

As illustrated in FIG. 7, the apparatus 100 for detecting a malicious mail may determine a user corresponding to the risk candidate account as the risk candidate account, and may determine the detection target mail corresponding to the risk candidate mail as the risk candidate mail.

In an exemplary embodiment, the detection target mail may be marked as a risk candidate mail when the detection target mail is determined as the risk candidate mail. For example, when a user opens the detection target mail, a flag may be automatically displayed in the detection target mail as an indication of the risk candidate account.

In an exemplary embodiment, the account of the user may be marked as a risk candidate account if determined to be the risk candidate account. For example, a flag may be automatically displayed in the account of the user as the indication of the risk candidate account.

As the flag is automatically displayed in the detection target mail as the indication of the risk candidate account or the flag is automatically displayed in the account of the user as the indication of the risk candidate account, users may check the flags displayed on their accounts or mails, check for scam attacks, and prevent damage in advance.

The determined risk candidate account or risk candidate email may be used for an operation of the history analysis module 133 to be described later.

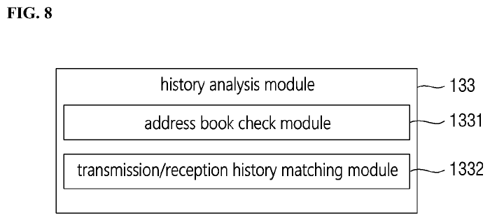

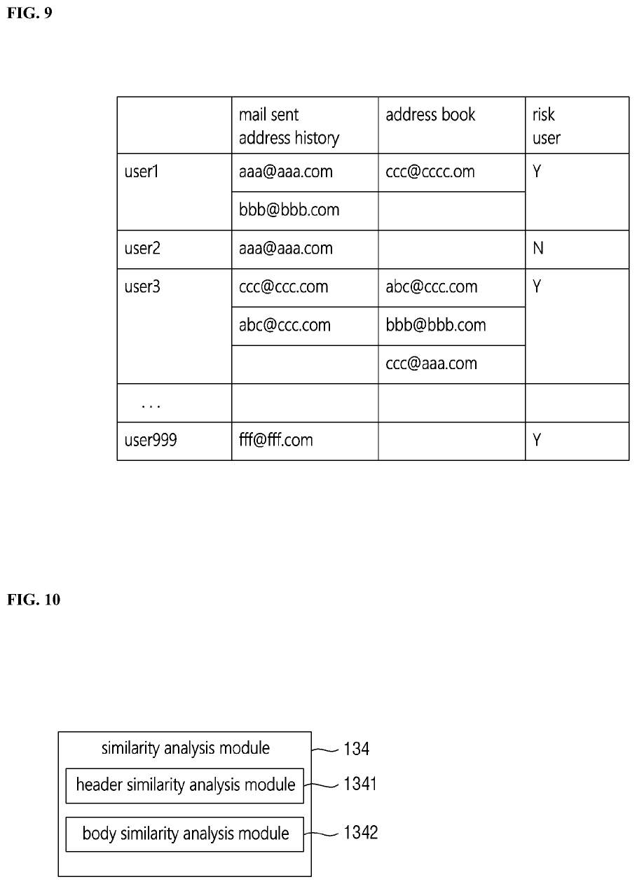

FIG. 8 is a block diagram for specifically explaining the history analysis module 133 described in FIG. 3, and FIG. 9 is a diagram for explaining transmission/reception history information of a user using e-mail and an address book set in a user account.

The history analysis module 133 may include an address book check module 1331 and a transmission/reception history matching module 1332.

The address book check module 1331 may determine whether the sender information of the detection target mail matches the user's address book included in the account characteristic information.

As illustrated in FIG. 9, ‘ccc@cccc.com’ is stored in an address book of user 1, no address is stored in an address book of user 2, ‘abc@ccc.com’, ‘bbb@bbb.com’, and ‘ccc@aaa.com’ are stored in an address book of user 3, and no address is stored in an address book of user 999.

If the sender of the detection target mail is stored in the user's address book, that is, if the address book check module 1331 determines that the sender information of the detection target mail matches the user's address book, the operation of the transmission/reception history matching module 1332 may be terminated without being performed. Since the sender information checked by the address book check module 1331 may be determined to be safe, the operation may be stopped without detecting whether the detection target mail is a malicious mail any longer.

If it is determined by the address book check module 1331 that the sender information of the detection target mail does not match the user's address book, the operation of the transmission/reception history matching module 1332 may be performed.

The transmission/reception history matching module 1332 may determine the detection target mail as the malicious mail when the sender information of the detection target mail does not match the transmission/reception history information. The transmission/reception history matching module 1332 may determine whether the sender information identified in the detection target mail matches the transmission/reception history information of the account of the user based on the transmission/reception history information of the mail used by the user.

As illustrated in FIG. 9, ‘aaa@aaa.com’ and ‘bbb@bbb.com’ are stored in a mail transmission/reception history of user 1, ‘aaa@aaa.com’ is stored in a mail transmission/reception history of user 2, ccc@ccc.com′ and ‘abc@ccc.com’ are stored in a mail transmission/reception history of user 3, and iff@fff.com′ is stored in a mail transmission/reception history of user 999.

The transmission/reception history matching module 1332 may determine whether the sender information identified in the detection target mail matches the transmission/reception history information based on the transmission/reception history information, and may determine the detection target mail as the malicious mail when the sender information of the detection target mail does not match the transmission/reception history information.

In an exemplary embodiment, if the sender information of the detection target mail does not match the transmission/reception history information, the detection target mail may be determined as the malicious mail when the detection target mail is the risk candidate mail and may not be determined as the malicious mail when the detection target mail is not the risk candidate mail, depending on whether the detection target mail is the risk candidate mail or not.

In addition, in an exemplary embodiment, if the sender information of the detection target mail does not match the transmission/reception history information, whether the detection target mail is a malicious mail may be determined by comprehensively considering i) whether the account of the user is the risk candidate account and ii) whether the detection target mail is the risk candidate mail.

The apparatus 100 for detecting a malicious mail according to an exemplary embodiment may accurately detect the malicious mail by considering a logical flow based on a user's mail history and characteristics of a user.

FIG. 10 is a block diagram for specifically explaining the similarity analysis module 134 described in FIG. 3.

The similarity analysis module 134 may determine the detection target mail as a malicious mail by using the sender information and the recipient information included in the header of the detection target mail and the sender information included in the body of the detection target mail.

The similarity analysis module 134 may include a header similarity analysis module 1341 and a body similarity analysis module 1342.

The header similarity analysis module 1341 may calculate a similarity score based on domains of the sender information and the recipient information included in the header of the detection target mail, and may determine the detection target mail as the malicious mail when the calculated similarity score is not a perfect mismatch or a perfect match. In an exemplary embodiment, the similarity score may be determined from 0 to 100, and the similarity score of 0 may mean a perfect mismatch and the similarity score of 100 may mean a perfect match.

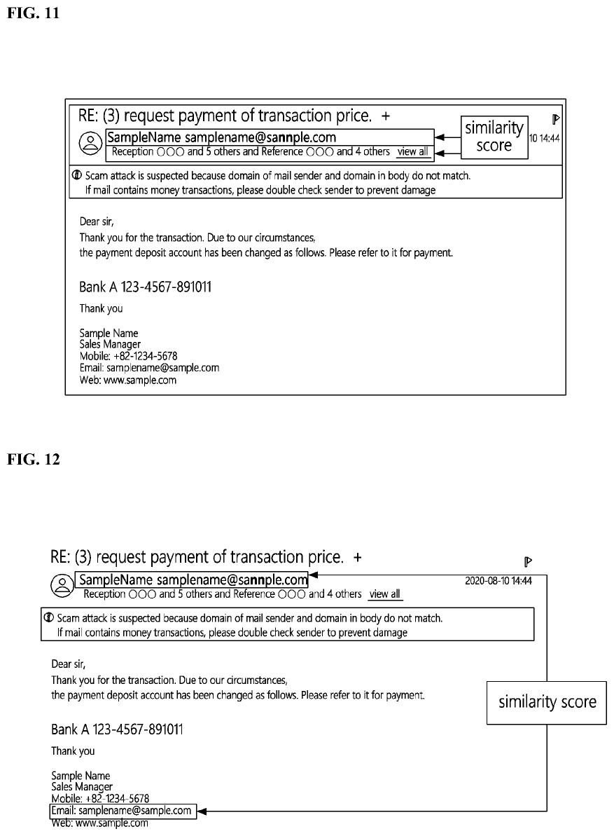

The header similarity analysis module 1341 may calculate the similarity score by comparing a domain sannple.com′ extracted from the sender information (samplename@sannple.com′) included in the header of the detection target mail and a domain sample.com′ extracted from the recipient information as illustrated in FIG. 11.

The header similarity analysis module 1341 may determine the detection target mail as the malicious mail when the domains do not perfectly match or perfectly mismatch, but partially match as described above.

The body similarity analysis module 1342 may calculate a similarity score based on a domain of the sender information included in the header of the detection target mail and a domain of the sender information included in the body of the detection target mail, and may determine the detection target mail as the malicious mail when the calculated similarity score is not a perfect mismatch or a perfect match. In an exemplary embodiment, the similarity score may be determined from 0 to 100, and the similarity score of 0 may mean a perfect mismatch and the similarity score of 100 may mean a perfect match.

The body similarity analysis module 1342 may calculate the similarity score by comparing samplename@sannple.com′, the sender information included in the header of the detection target mail, with sampleName@sample.com′, the sender information included in the body (e.g., domain comparison).

The body similarity analysis module 1342 may determine the detection target mail as the malicious mail when the domains do not perfectly match or perfectly mismatch, but partially match as described above.

As described above, the apparatus 100 for detecting a malicious mail according to an exemplary embodiment may determine the malicious mail more accurately because of performing the determination by considering both the sender and the body of the mail.

So far, the detailed configuration of the analysis module 130 has been described with reference to FIGS. 4 to 12. Hereinafter, the remaining configurations will be described.

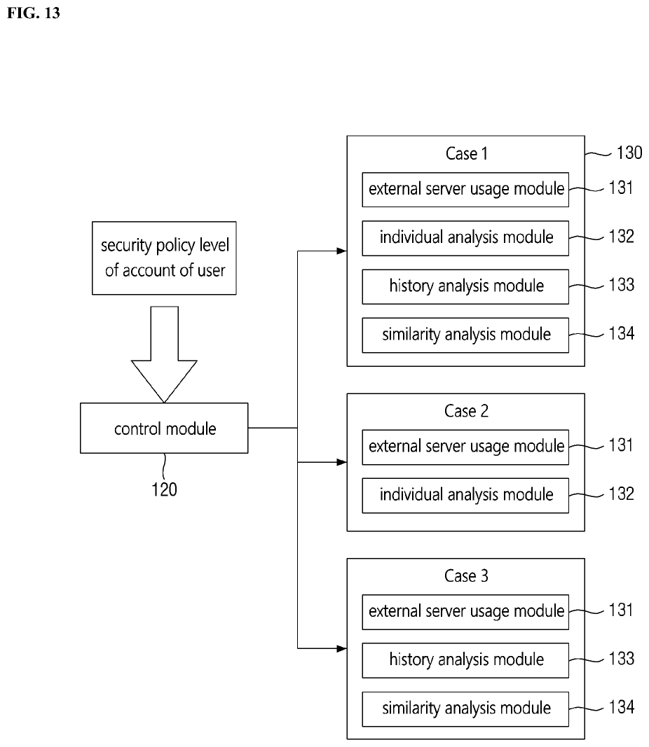

FIG. 13 is a diagram for explaining a case in which logic for operating an analysis module 130 is determined by an operation of a control module 120.

The control module 120 may determine the logic of the external server usage module 131, the individual analysis module 132, the history analysis module 133, and the similarity analysis module 134 included in the analysis module 130, according to the security policy level set for the account of the user before the analysis module 130 operates.

For example, the logic of analysis module 130 may be determined in a variety of ways. If the security policy level is a default value, the logic of the analysis module 130 may be determined as the external server usage module 131, the individual analysis module 132, the history analysis module 133, and the similarity analysis module 134 according to case 1.

If the security policy level is set to only receive information on the risk candidate mail or risk candidate account, the logic of the analysis module 130 may be determined as the external server usage module 131 and the individual analysis module 132 according to case 2.

If the risk candidate account is a clear user the logic of the analysis module 130 may be determined as the external server usage module 131, the individual analysis module 132, the history analysis module 133, and the similarity analysis module 134 according to case 3.

Since the apparatus 100 for detecting a malicious mail according to an exemplary embodiment uses the control module 120 that selectively applies the analysis module 130, it is possible to efficiently manage inspection performance resources in detecting the malicious mail. Accordingly, resource consumption and expense due to excessive detection may be reduced.

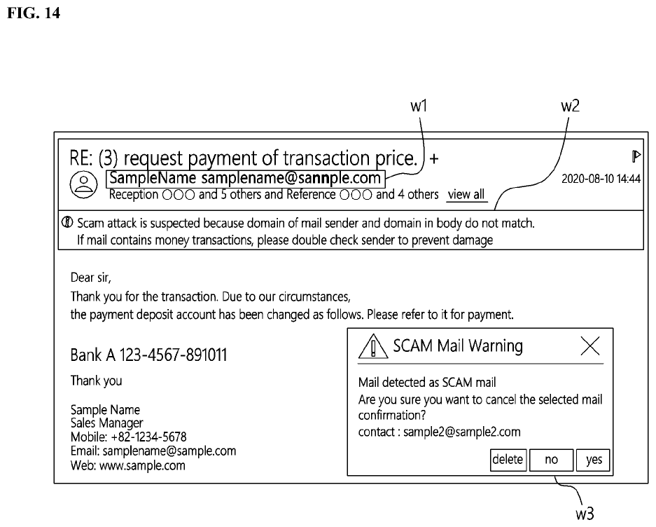

FIG. 14 is a diagram illustrating an example of displaying a risk notification on a detection target mail determined as a malicious mail.

The result providing module 140 may provide a risk notification capable of identifying the malicious mail to the detection target mail determined as the malicious mail.

In this case, the risk notification may display a notification that the detection target mail is a malicious mail in the header or body of the detection target mail determined as the malicious mail, or may be a pop-up warning window.

For example, in the sender information of the header of FIG. 14, a notification w1 indicating that it is a malicious mail may be displayed, a notification w2 indicating ‘Scam attack is suspected because the domain of a mail sender and a domain in the body do not match. If the mail contains money transactions, please double check the sender to prevent damage’ may be displayed, and a notification window w3 indicating a scam mail warning may be displayed.

In another exemplary embodiment, the risk notification may be applied in various forms such as mail blocking, mail movement, pop-up warning, and ribbon warning.

So far, the configuration and operation of the apparatus 100 for detecting a malicious mail according to an exemplary embodiment have been described with reference to FIGS. 2 to 14.

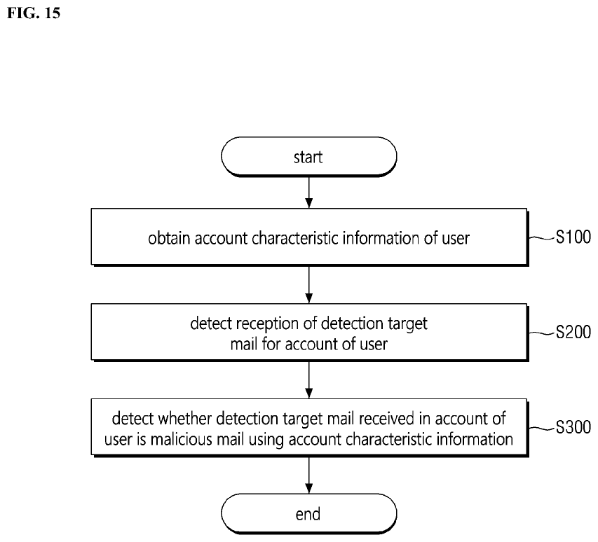

Hereinafter, a method for detecting a malicious mail according to an exemplary embodiment will be described with reference to FIGS. 15 to 21. The method for detecting a malicious mail may be performed in a computing device. Here, the computing device may be the apparatus 100 for detecting a malicious mail described with reference to FIGS. 2 to 14. Hereinafter, contents overlapping the apparatus 100 for detecting a malicious mail described above will be omitted.

In step S100 of FIG. 15, a step of obtaining account characteristic information of a user using a mail may be performed, in step S200, a reception of a detection target mail for an account of the user may be detected, and in step S300, it may be detected whether the detection target mail received in the account of the user is a malicious mail by using the account characteristic information.

When the account characteristics information of the user using the mail is obtained in step S100, the account characteristics information of the user may be obtained by monitoring mail transmitted to and received from the account of the user. In this case, the account characteristic information of the user may be obtained using various types of information generated in a process of transmitting and receiving the mail.

The account characteristic information may include at least one of a risk keyword usage frequency indicating a frequency at which a pre-designated risk keyword is used in the account of the user, a risk keyword transmission frequency indicating a frequency at which a mail including the pre-designated risk keyword is transmitted from the account of the user, address book information set in the account of the user, and transmission/reception history information on the mail used by the user.

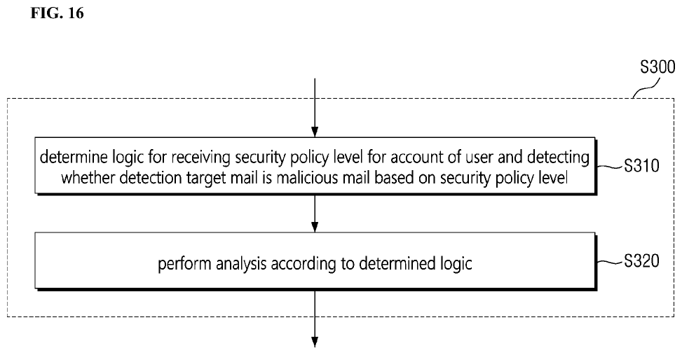

As illustrated in FIG. 16, when step S300 is performed, logic for detecting whether the detection target mail is the malicious mail based on a security policy level set for the account of the user may be determined before a step of detecting whether the detection target mail is a malicious mail in step S310, and an analysis may be performed according to the determined logic in step S320.

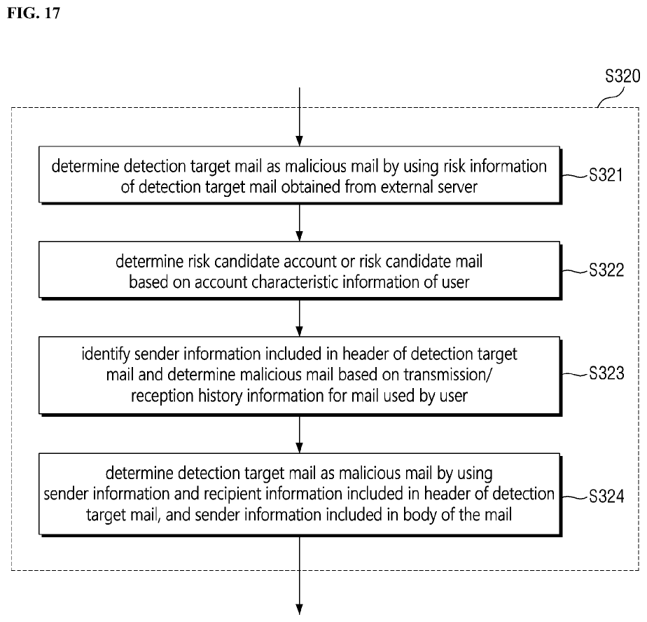

When the analysis is performed in step S320, steps S321, S322, S323, and S324 may be performed specifically as illustrated in FIG. 17.

In step S321, the detection target mail may be determined as the malicious mail by using risk information of the detection target mail obtained from an external server.

Then, in step S322, a risk candidate account or a risk candidate mail may be determined based on the user's account characteristic information.

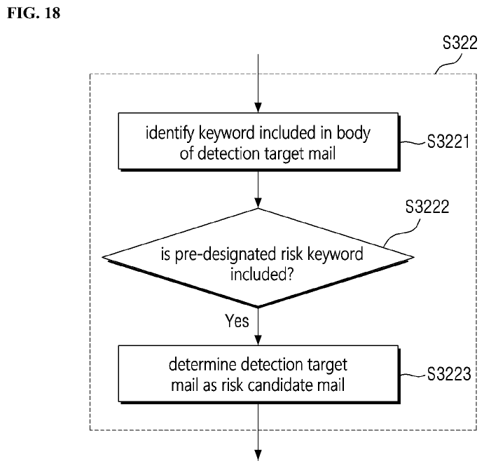

Step S322 will be described in more detail. As illustrated in FIG. 18, in step S3221, keywords included in the body of the detection target mail may be identified, in step S3222, it is determined whether a pre-designated risk keyword is included in the keywords included in the body of the detection target mail, and in step S3223, if the pre-designated risk keyword is included, the detection target mail may be determined as a risk candidate mail. Here, the pre-designated risk keyword may be a keyword related to a contract, purchase, or finance, but is not limited thereto.

In an exemplary embodiment, the detection target mail may be marked as a risk candidate mail when the detection target mail is determined as the risk candidate mail. For example, when a user opens the detection target mail, a flag may be displayed in the detection target mail as an indication of the risk candidate account.

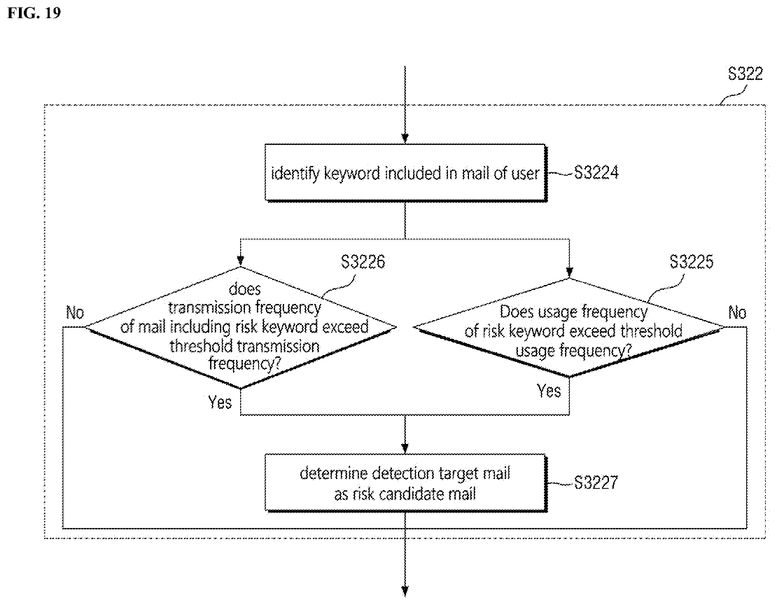

Step S322 will be described in more detail. As illustrated in FIG. 19, in step S3224, keywords included in the mail of the user may be identified, in step S3225, it may be determined whether the risk keyword usage frequency in the account of the user exceeds the threshold usage frequency, and if the risk keyword usage frequency in the account of the user exceeds the threshold usage frequency, the account of the user may be determined as the risk candidate account in step S3227.

In step S3226, it is determined whether the transmission frequency of the risk keyword used in the account of the user is within the threshold transmission frequency, and if the transmission frequency of the risk keyword used in the account of the user is within the threshold transmission frequency, the account of the user may be determined as the risk candidate account in step S3227.

As step S322 is performed, the user corresponding to the risk candidate account may be determined as the risk candidate account, and the detection target mail corresponding to the risk candidate mail may be determined as the risk candidate mail.

In an exemplary embodiment, the account of the user may be marked as the risk candidate account if determined to be the risk candidate account. For example, a flag may be displayed as the indication of the risk candidate account.

The determined risk candidate account or risk candidate mail may be used in step S323.

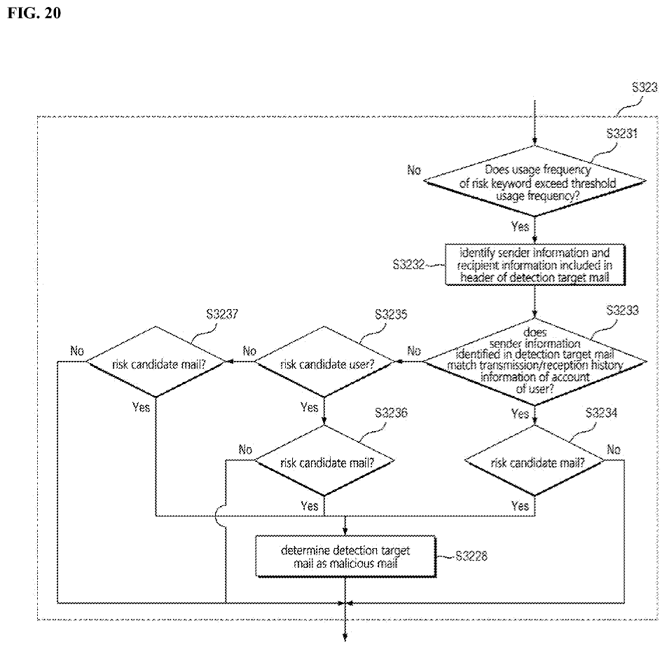

FIG. 20 is a flowchart illustrating an operation of determining a malicious mail using a user's address book and transmission/reception history information.

If the sender information of the detection target mail matches the address book, the detection target mail is determined to be safe, and the operation of step S323 may end.

First, in step S3231, the sender information is identified in the detection target mail, and in step S3232, if the sender information of the detection target mail does not match the address book, step S3233 may be performed.

In step S3233, it may be determined whether the sender information of the detection target mail matches the transmission/reception history information of the account of the user based on the transmission/reception history information of the mail used by the user.

If the sender information of the detection target mail matches the transmission/reception history information of the account of the user in step S3233, in step S3234, the detection target mail may be determined as the malicious mail if the detection target mail is a risk candidate mail, and the detection target mail may not be determined as the malicious mail if the detection target mail is not the risk candidate mail.

If the sender information of the detection target mail does not match the transmission/reception history information of the account of the user in step S3233, step S3235 may be performed. In this case, it is determined in step S3235 whether the account of the user is the risk candidate account, and if the account of the user is the risk candidate account, step S3236 may be performed. If it is determined in S3236 that the detection target mail is the risk candidate mail, the detection target mail may be determined as the malicious mail. If the detection target mail is not the risk candidate mail in step S3236, step S323 may end.

If it is determined in step S3235 that the account of the user is not the risk candidate account, step S3237 may be performed. If the detection target mail is the risk candidate mail in step S3227, the detection target mail may be determined as the malicious mail when the account of the user is determined as the risk candidate mail. If the detection target mail is not the risk candidate mail in step S323, step S323 may end.

The method for detecting a malicious mail according to an exemplary embodiment may accurately detect the malicious mail by considering a logical flow based on a user's mail history and characteristics of a user.

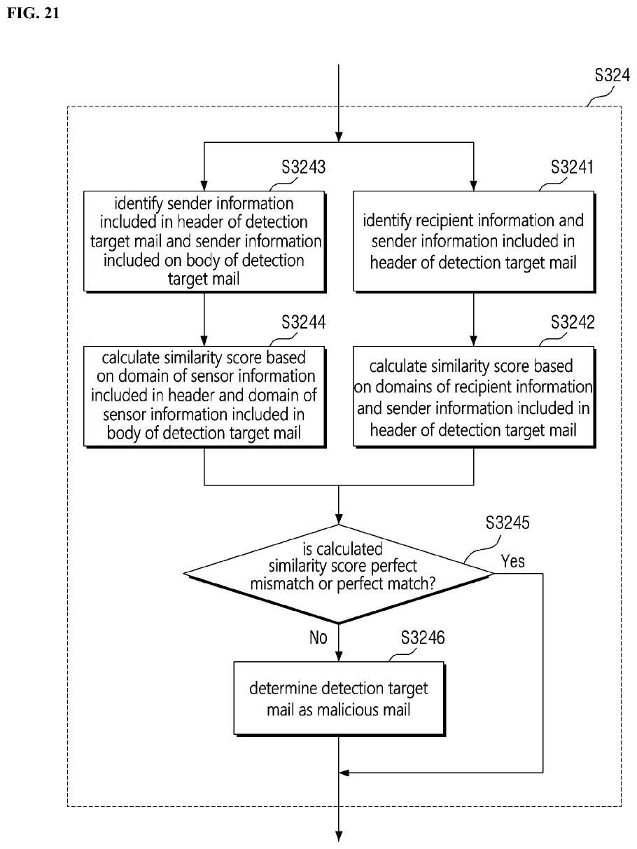

FIG. 21 is a flowchart illustrating an operation of determining a malicious mail using sender information and recipient information included in the header and body of the detection target mail.

When the malicious mail is determined in step S324, steps S3241, S3242, S3243, S3244, S3245, and S3246 may be performed.

In steps S3241 and S3242, the malicious mail may be determined using sender information and recipient information included in the header of the detection target mail. First, in step S3241, the recipient information and the sender information included in the header of the detection target mail may be identified. In step S3242, a similarity score may be calculated based on the domains of the sender information and the recipient information included in the header of the detection target mail.

If the similarity score calculated in step S3245 is not a perfect mismatch or a perfect match, the detection target mail may be determined as the malicious mail in step S3246. In an exemplary embodiment, the similarity score may be determined from 0 to 100, and the similarity score of 0 may mean a perfect mismatch and the similarity score of 100 may mean a perfect match.

In steps S3243 and 3244, the malicious mail may be determined based on the domain of the sender information included in the header of the detection target mail and the domain of the sender information included in the body of the detection target mail.

In step S3243, the domain of the sender information included in the header of the detection target mail and the domain of the sender information included in the body of the detection target mail may be identified.

In step S3244, a similarity score between the domain of the sender information included in the header of the detection target mail and the domain of the sender information included in the body of the detection target mail may be calculated.

If the similarity score calculated in step S3245 is not a perfect mismatch or a perfect match, the detection target mail may be determined as the malicious mail in step S3246. In an exemplary embodiment, the similarity score may be determined from 0 to 100, and the similarity score of 0 may mean a perfect mismatch and the similarity score of 100 may mean a perfect match.

As described above, according to an exemplary embodiment, since the determination is performed by considering both the sender and the body of the mail, the malicious mail may be determined more accurately.

In a method for detecting a malicious mail according to another exemplary embodiment, obtaining transmission/reception history information of a user using mail, detecting a reception of detection target mail for an account of the user, and detecting whether the detection target mail is the malicious mail based on transmission/reception history information for the mail of the user and pre-designated risk keywords may be performed.

In an exemplary embodiment, when the detecting of whether the detection target mail is the malicious mail based on the transmission/reception history information of the mail of the user is performed, a score representing a related context (or a contextual relationship) of a thread of a mail already received in the account of the user included in the transmission/reception history information and the detection target mail may be calculated, and when the score representing the related context of the thread of the mail already received in the account of the user and the detection target mail is a threshold value or less, the detection target mail may be determined as the malicious mail.

Here, the score representing the related context of the mail may be a score calculated based on relevance between subjects, a score calculated based on relevance between bodies, and a score using whether or not the sender and receiver match.

So far, the operation of the method for detecting a malicious mail according to an exemplary embodiment of the present disclosure has been described.

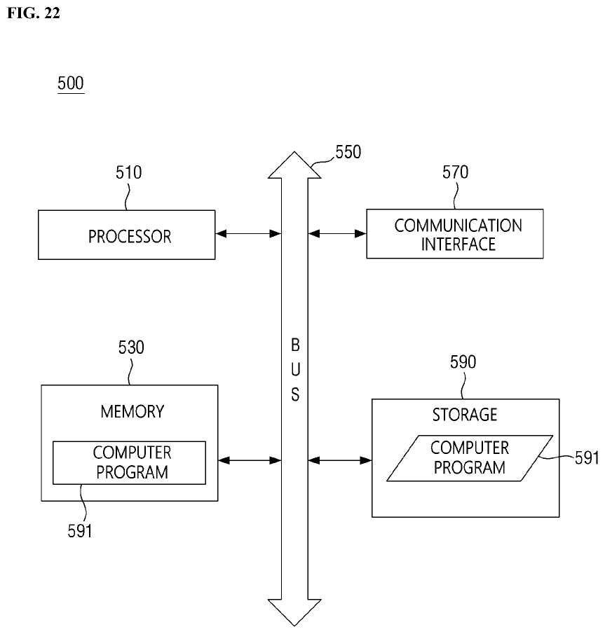

Hereinafter, an exemplary computing device 500 in which the apparatus described in various exemplary embodiments of the present disclosure may be implemented will be described with reference to FIG. 22.

FIG. 22 is an exemplary hardware configuration diagram illustrating the computing device 500.

As illustrated in FIG. 22, the computing device 500 may include one or more processors 510, a bus 550, a communication interface 570, a memory 530 for loading a computer program 591 executed by the processor 510, and a storage 590 for storing the computer program 591. However, only the components related to the exemplary embodiments of the present disclosure are illustrated in FIG. 22. Accordingly, those skilled in the art to which the present disclosure pertains may see that other general-purpose components other than the components illustrated in FIG. 22 may be further included.

The processor 510 controls the overall operation of each component of the computing device 500. The processor 510 may be configured to include at least one of a central processing unit (CPU), a micro processor unit (MPU), a micro controller unit (MCU), a graphic processing unit (GPU), or any type of processor well known in the art. In addition, the processor 510 may perform a calculation on at least one application or program for executing the methods/operations according to various exemplary embodiments of the present disclosure. The computing device 500 may include one or more processors.

The memory 530 stores various data, instructions, and/or information. The memory 530 may load one or more programs 591 from the storage 590 to execute the methods/operations according to various embodiments of the present disclosure. For example, when the computer program 591 is loaded into the memory 530, the logic (or module) as illustrated in FIG. 4 may be implemented on the memory 530. An example of the memory 530 may be a RAM, but is not limited thereto.

The bus 550 provides a communication function between the components of the computing device 500. The bus 550 may be implemented as various types of buses, such as an address bus, a data bus, and a control bus.

The communication interface 570 supports wired/wireless Internet communication of the computing device 500. The communication interface 570 may also support various communication methods other than Internet communication. To this end, the communication interface 570 may include a communication module well known in the art of the present disclosure.

The storage 590 may non-temporarily store one or more computer programs 591. The storage 590 may include a non-volatile memory such as a read only memory (ROM), an erasable programmable ROM (EPROM), an electrically erasable programmable ROM (EEPROM), a flash memory, or the like, a hard disk, a removable disk, or any form of computer-readable recording medium well known in the art to which the present disclosure pertains.

The computer program 591 may include one or more instructions in which the methods/operations according to various exemplary embodiments of the present disclosure are implemented. When the computer program 591 is loaded into the memory 530, the processor 510 may perform the methods/operations according to various exemplary embodiments of the present disclosure by executing the one or more instructions.

In an exemplary embodiment, the computer program may include an instruction for obtaining account characteristic information of a user using mail, an instruction for detecting a reception of a detection target mail for an account of the user and an instruction for detecting whether the detection target mail received in the account of the user is a malicious mail by using the account characteristic information.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results may be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications may be made to the example embodiments without substantially departing from the principles of the present disclosure. Therefore, the disclosed example embodiments of the disclosure are used in a generic and descriptive sense only and not for purposes of limitation.

What is claimed is:

1. A method for detecting a malicious mail performed by at least one processor, the method comprising:
obtaining account characteristic information of an account of a user;
detecting a reception of a detection target mail in the account of the user; and
detecting whether the detection target mail received in the account of the user is a malicious mail by using the account characteristic information.

2. The method of claim 1, wherein the account characteristic information includes at least one of a risk keyword usage frequency indicating a frequency at which a pre-designated risk keyword is used in the account of the user, a risk keyword transmission frequency indicating a frequency at which a mail including the pre-designated risk keyword is transmitted from the account of the user, address book information set in the account of the user, or transmission and/or reception history information of a mail in the account of the user.

3. The method of claim 1, wherein the obtaining the account characteristic information comprises obtaining the account characteristic information of the account of the user by monitoring a mail transmitted to and/or received from the account of the user.

4. The method of claim 1, further comprising, prior to the detecting whether the detection target mail is the malicious mail:
determining logic for detecting whether the detection target mail is the malicious mail based on a security policy level set for the account of the user.

5. The method of claim 1, wherein the detecting whether the detection target mail is the malicious mail comprises determining the detection target mail as the malicious mail by using risk information of the detection target mail obtained from an external server.

6. The method of claim 1, wherein the detecting whether the detection target mail is the malicious mail comprises:
identifying a keyword included in a body of the detection target mail; and
determining whether a pre-designated risk keyword is included in the body of the detection target mail, and determining the detection target mail as a risk candidate mail based on the pre-designated risk keyword being included.

7. The method of claim 1, wherein the account characteristic information includes a risk keyword usage frequency indicating a frequency at which a pre-designated risk keyword is used in the account of the user, and
the detecting whether the detection target mail is the malicious mail comprises determining the account of the user as a risk candidate account based on the risk keyword usage frequency in the account of the user exceeding a threshold usage frequency.

8. The method of claim 1, wherein the account characteristic information includes a risk keyword transmission frequency indicating a frequency at which a mail including a pre-designated risk keyword is transmitted from the account of the user, and
the detecting whether the detection target mail is the malicious mail comprises determining the account of the user as a risk candidate account based on the risk keyword transmission frequency in the account of the user being within a threshold transmission frequency.

9. The method of claim 1, wherein the account characteristic information includes an address book set in the account of the user, and
the detecting whether the detection target mail is the malicious mail comprises:
identifying sender information in the detection target mail; and
performing an operation of detecting whether the detection target mail is the malicious mail based on the sender information of the detection target mail not matching the address book.

10. The method of claim 1, wherein the account characteristic information includes transmission and/or reception history information of the account of by the user, and
the detecting whether the detection target mail is the malicious mail comprises:
identifying sender information in the detection target mail; and
determining whether the sender information of the detection target mail matches the transmission and/or reception history information of the account of the user.

11. The method of claim 10, wherein the detecting whether the detection target mail is the malicious mail further comprises determining the detection target mail as the malicious mail based on the sender information of the detection target mail not matching the transmission and/or reception history information of the account of the user.

12. The method of claim 1, wherein the detecting whether the detection target mail is the malicious mail comprises:
identifying sender information and recipient information included in a header of the detection target mail;
calculating a similarity score based on a domain of the sender information and a domain of the recipient information included in the header of the detection target mail; and
determining the detection target mail as the malicious mail, based on the calculated similarity score not being a perfect mismatch or a perfect match.

13. The method of claim 1, wherein the detecting whether the detection target mail is the malicious mail comprises:
identifying sender information included in a header of the detection target mail and sender information included in a body of the detection target mail;
calculating a similarity score based on a domain of the sender information included in the header of the detection target mail and a domain of the sender information included in the body of the detection target mail; and
determining the detection target mail as the malicious mail, based on the calculated similarity score not being a perfect mismatch or a perfect match.

14. The method of claim 1, further comprising:
providing a risk notification capable of identifying the malicious mail to the detection target mail determined as the malicious mail.

15. A method for detecting a malicious mail performed by at least one processor, the method comprising:
obtaining transmission and/or reception history information of an account of a user;
detecting a reception of a detection target mail in the account of the user; and
detecting whether the detection target mail is a malicious mail based on the transmission and/or reception history information of the account of the user and a pre-designated risk keyword.

16. The method of claim 15, wherein the detecting whether the detection target mail is the malicious mail based on the transmission and/or reception history information of the mail of the user comprises:
calculating a score, which represents a contextual relationship between a thread of a mail already received in the account of the user and the detection target mail, the thread of the mail being included in the transmission and/or reception history information; and
determining the detection target mail as the malicious mail based on the calculated score being a threshold value or less.

17. An apparatus for detecting a malicious mail, the apparatus comprising at least one processor to implement:
a monitoring module configured to obtain account characteristic information of an account of a user by monitoring a mail transmission and/or reception operation in the account of the user; and
an analysis module configured to detect, based on detection of a reception of a detection target mail in the account of the user, whether the detection target mail received in the account of the user is a malicious mail by using the account characteristic information.

18. The apparatus of claim 17, wherein the analysis module comprises an individual analysis module configured to determine at least one of a risk candidate account or a risk candidate mail based on the account characteristic information.

19. The apparatus of claim 17, wherein the account characteristic information includes transmission and/or reception history information of the account of the user, and
the analysis module comprises a history analysis module configured to identify sender information included in the detection target mail and determine the malicious mail based on transmission and/or reception history information of the account of the user.

20. The apparatus of claim 17, wherein the analysis module comprises a similarity analysis module configured to determine the detection target mail as the malicious mail by using sender information and recipient information included in a header of the detection target mail and sender information included in a body of the detection target mail.
